(19) United States
(12) Patent Application Publication
(10) Pub. No.: US 2026/0371223 A1
(43) Pub. Date: Nov. 19, 2026

(54) MESH BACKHAUL TOPOLOGY OPTIMIZATION METHOD AND ROUTER DEVICE USING THE SAME

(71) Applicant: ASUSTeK COMPUTER INC., Taipei City (TW)

(72) Inventors: Lu-Ping Chou, Taipei City (TW); Jhih-Wei Jian, Taipei City (TW)

(73) Assignee: ASUSTeK COMPUTER INC., Taipei City (TW)

(21) Appl. No.: 19/663,175

(22) Filed: Apr. 29, 2026

(30) Foreign Application Priority Data
May 14, 2025 (TW) 114118152

(51) Int. Cl. H04W 40/30; H04W 74/0816; H04W 84/18

(52) U.S. Cl. CPC H04W 40/30; H04W 74/0816; H04W 84/18

(57) ABSTRACT

A mesh backhaul topology optimization method and a router device are provided. The method is adapted to the router device being a main router of a mesh network and comprises the following steps. Whether an optimization trigger condition is met is determined. When the optimization triggering condition is met, the path cost of each of direct link paths are determined based on wireless environment information of multiple sub-routers in the mesh network. Based on the path costs of the direct link paths, an optimal backhaul path from each sub-router to the main router is determined. Each of the sub-routers is controlled to connect to the mesh network according to the corresponding optimal backhaul path.

### CROSS-REFERENCE TO RELATED APPLICATION

This application claims the priority benefit of Taiwan application serial no. 114118152, filed on May. 14, 2025. The entirety of the above-mentioned patent application is hereby incorporated by reference herein and made a part of this specification.

### BACKGROUND

### TECHNICAL FIELD

The disclosure relates to a mesh backhaul topology optimization method and a router device using the same.

### RELATED ART

A mesh network is a wireless network architecture in which each node (such as a router) forms a self-organizing network through wireless connections. The topology structure of a mesh network improves the reliability and scalability of the network. Mesh backhaul refers to the data transmission channels between nodes in a mesh network, configured to connect each node and achieve internal communication of the entire network. In traditional mesh network systems, when a certain sub-node joins the mesh network, the optimal backhaul path for connecting to the main router is selected for that sub-node at that time. Once the sub-node maintains connection after establishing the connection, the optimal backhaul path of the sub-node remains unchanged. However, this static routing strategy has limitations. As wireless environment conditions change (such as new nodes joining, new nodes being removed, interference source variations), the originally effective optimal backhaul path becomes inefficient or severely interfered, resulting in network performance degradation. That is, since the mesh network system cannot update the mesh backhaul topology in a timely manner, this makes the mesh network system unable to adequately respond to dynamic environment challenges, resulting in unsatisfactory network performance.

### SUMMARY

The disclosure provides a mesh backhaul topology optimization method, adapted to a main router of a mesh network, and comprises the following steps. Whether an optimization triggering condition is satisfied is determined. When the optimization triggering condition is satisfied, a path cost of each of direct link paths is determined according to wireless environment information of a plurality of sub-routers of the mesh network. According to the path costs of the direct link paths, an optimal backhaul path for each of the sub-routers to connect to the main router is determined. Each of the sub-routers is controlled to connect to the mesh network according to the corresponding optimal backhaul path.

The disclosure further provides a router device, which serves as a main router of a mesh network, and comprises a transceiver, a storage device, and a processor. The processor is coupled to the transceiver and the storage device, and is configured to execute the following operations. Whether an optimization triggering condition is satisfied is determined. When the optimization triggering condition is satisfied, a path cost of each of direct link paths is determined according to wireless environment information of a plurality of sub-routers of the mesh network. According to the path costs of the direct link paths, an optimal backhaul path for each of the sub-routers to connect to the main router is determined. Each of the sub-routers is controlled to connect to the mesh network according to the corresponding optimal backhaul path.

Based on the above, in the embodiments of the disclosure, the main router determines whether the optimization triggering condition is satisfied. When it is determined that the optimization triggering condition is satisfied, the main router collects wireless environment information of multiple sub-routers of the mesh network to determine respective path costs of multiple direct link paths. Thus, the main router determines an optimal backhaul path for each sub-router to connect to the main router according to the path costs of the direct link paths, so that each sub-router connects to the mesh network according to the corresponding optimal backhaul path. In this way, the main router updates the topology of the mesh backhaul in a timely manner in response to change of wireless environment condition.

### BRIEF DESCRIPTION OF THE DRAWINGS

FIG. 1 is a schematic diagram of a network system according to an embodiment of the disclosure.

FIG. 2 is a schematic diagram of a router device according to an embodiment of the disclosure.

FIG. 3 is a flowchart of a mesh backhaul topology optimization method according to an embodiment of the disclosure.

FIG. 4 is a flowchart of determining whether an optimization triggering condition is satisfied according to an embodiment of the disclosure.

FIG. 5 is a flowchart of determining an optimal backhaul path according to an embodiment of the disclosure.

FIG. 6 is a schematic diagram of determining an optimal backhaul path according to an embodiment of the disclosure.

FIG. 7A is a schematic diagram of a scenario for updating an optimal backhaul path according to an embodiment of the disclosure.

FIG. 7B is a schematic diagram of topology optimization of mesh backhaul according to an embodiment of the disclosure.

FIG. 8A is a schematic diagram of a scenario for updating an optimal backhaul path according to an embodiment of the disclosure.

FIG. 8B is a schematic diagram of topology optimization of mesh backhaul according to an embodiment of the disclosure.

### DESCRIPTION OF THE EMBODIMENTS

Some embodiments of the disclosure will now be described in detail with reference to the accompanying drawings. When the same element symbols appear in different drawings, they will be considered as the same or similar elements. These embodiments are only part of the invention and do not disclose all possible embodiments of the invention. More precisely, these embodiments are only examples of the devices and methods in the scope of claims of the disclosure.

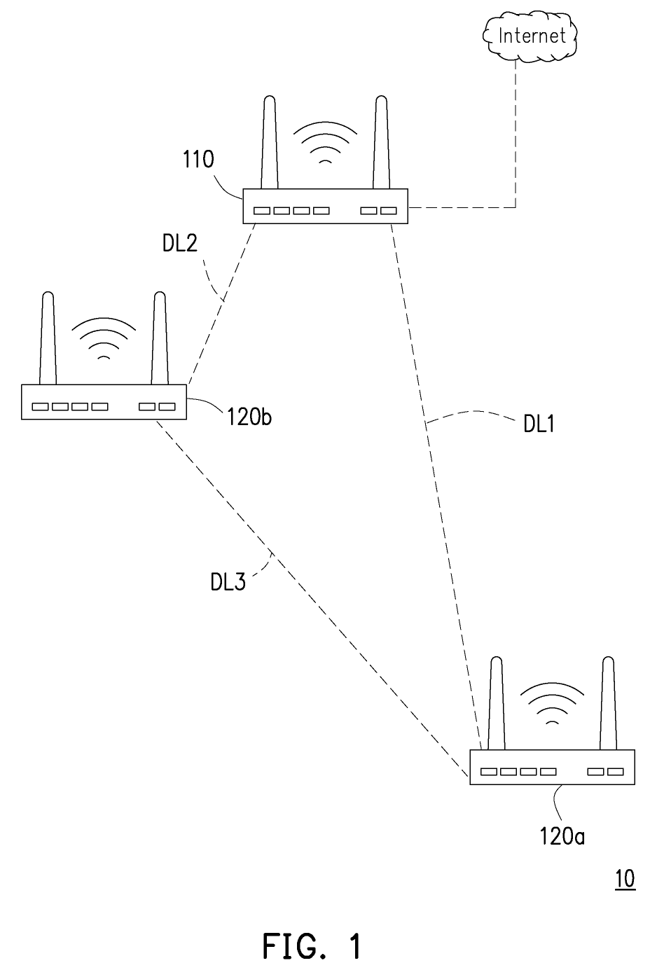

Referring to FIG. 1, which is a schematic diagram of a mesh network system according to an embodiment of the disclosure. The mesh network 10 comprises one main router (also referred to as main access point, central access point, or root access point) 110 and a plurality of sub-routers (also referred to as sub-access points, slave access points, or extended access points) 120a, 120b. However, although FIG. 1 illustrates two sub-routers 120a, 120b as an example, the disclosure does not limit the quantity of sub-nodes in the mesh network. The main router 110 serves as a gateway for the mesh network 10 to connect to the public Internet. The main router 110 connects to the Internet via a modem or optical fiber converter of an Internet Service Provider (ISP). In some embodiments, the main router 110 connects to the ISP's modem in a wired or wireless manner. Alternatively, the ISP's modem is integrated within the main router 110. The sub-routers 120a, 120b extends the coverage range of wireless signals.

In some embodiments, the main router 110 and the sub-routers 120a, 120b adopts 2.4GHz, 5GHz, or 6GHz frequency bands to perform wireless communication with terminal devices. The terminal devices connect to the main router 110 and the sub-routers 120a, 120b using a single SSID. Compared to establishing a networking environment using only a single main router device, the mesh network 10 with multiple wireless access nodes has advantages such as increasing the coverage area of the wireless network, improving stability and transmission rate, and so on. The terminal devices comprise smartphones, tablet computers, game consoles, notebook computers, desktop computers, smart home appliances, Internet of Things devices, and so on , but the disclosure is not limited thereto.

In some embodiments, the main router 110 and the sub-routers 120a, 120b are wireless routers that provide wireless communication functionality based on WiFi protocol. In some embodiments, the main router 110 and the sub-routers 120a, 120b supports IEEE 802.11 k/v/r protocol or IEEE 802.11s protocol. Alternatively, the main router 110 and the sub-routers 120a, 120b supports the EasyMesh standard established by Wi-Fi Alliance. In some embodiments, when the main router 110 and the sub-routers 120a, 120b construct WiFi mesh, the main router 110 serves as a central controller of Multiple Access Point (Multi-AP), while the sub-routers 120a, 120b serve as agent devices of Multi-AP.

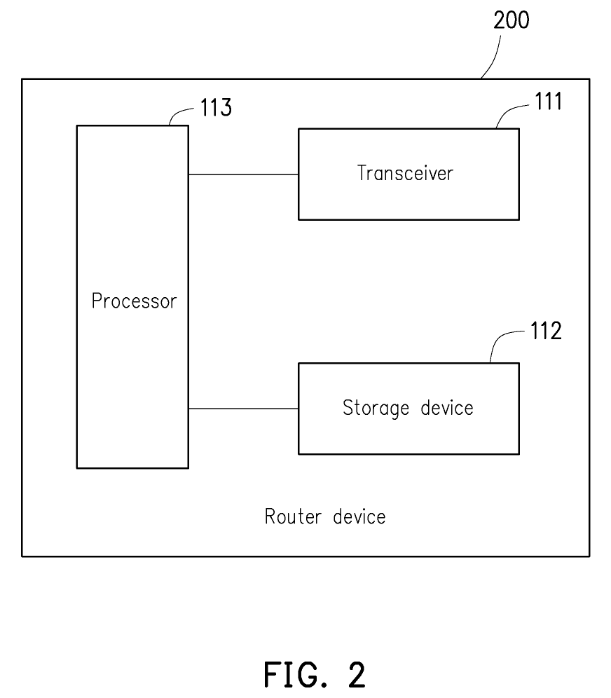

Referring to FIG. 2, which is a schematic diagram of a router device according to an embodiment of the disclosure. The router device 200 comprises a transceiver 111, a storage device 112, and a processor 113. The processor 113 is coupled to the transceiver 111 and the storage device 112. The router device 200 is an embodiment of the main router 110 in FIG. 1.

The transceiver 111 transmits and receives signals in a wireless or wired manner. The transceiver also executes operations such as low noise amplification, impedance matching, mixing, up or down frequency conversion, filtering, amplification, and similar operations. The router device 200 receives and transmits data through the transceiver 111. In some embodiments, the router device 200 also comprises an antenna.

The storage device 112 is configured to store data such as files, instructions, program codes, software modules, and so on, which is any type of fixed or removable random access memory (RAM), read-only memory (ROM), flash memory, or other similar devices, integrated circuits, or combinations thereof.

The processor 113 is, for example, a programmable general-purpose or special-purpose microprocessor, Digital Signal Processor (DSP), programmable controller, Application Specific Integrated Circuits (ASIC), Programmable Logic Device (PLD), or other similar devices or combinations of these devices.

The processor 113 executes program codes, software/firmware modules, instructions, and so on recorded in the storage device 112 to implement the mesh backhaul topology optimization method of the embodiments of the disclosure. That is, in some embodiments, the processor 113 is configured to execute operations of the main router 110 described hereinafter.

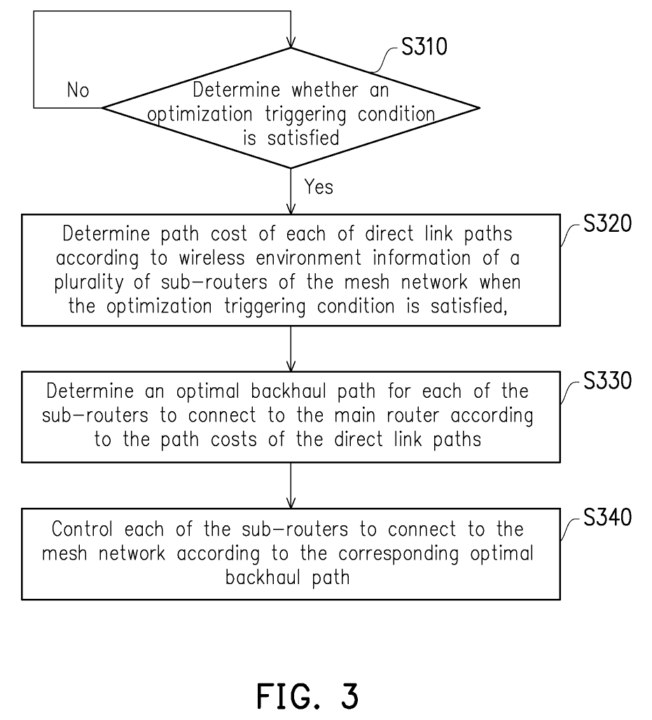

Referring to FIG. 3, which is a flowchart of a mesh backhaul topology optimization method according to an embodiment of the disclosure. In step S310, the main router 110 determines whether an optimization triggering condition is satisfied. In detail, according to whether an optimization triggering condition is satisfied, the main router 110 determines whether to optimize or update the backhaul topology of the mesh network 10. When the optimization triggering condition is satisfied, the main router 110 determines to optimize or update the backhaul topology of the mesh network 10, and search for an optimal backhaul path connecting to the main router 110 for each of the sub-routers 120a, 120b. When the optimization triggering condition is not satisfied, the main router 110 maintains the backhaul topology of the mesh network 10 unchanged.

In some embodiments, the optimization triggering condition comprises at least one of the following: the current time is a scheduled optimization time point, at least one of the sub-routers 120a, 120b executes a frequency band switching operation, whether the quantity of the sub-routers 120a, 120b connected to the mesh network 10 changes, and connection quality parameters measured by the sub-routers 120a, 120b satisfy a change condition. That is, the main router 110 optimizes or updates the backhaul topology of the mesh network 10 in response to changes in the wireless network environment. Alternatively, the main router 110 periodically optimizes or updates the backhaul topology of the mesh network 10.

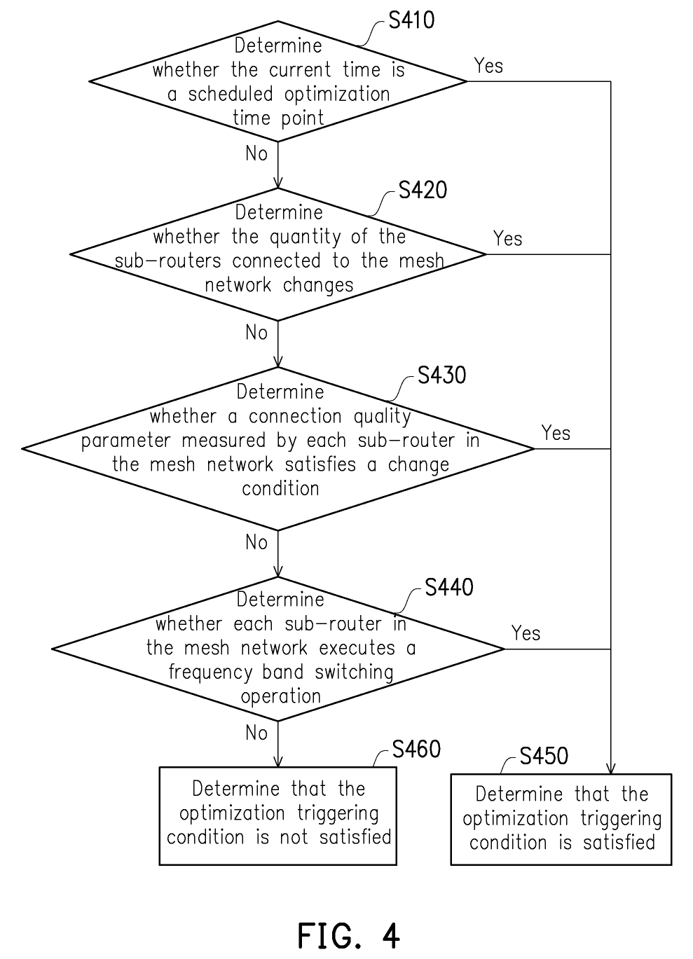

Referring to FIG. 4, which is a flowchart of determining whether an optimization triggering condition is satisfied according to an embodiment of the disclosure. In some embodiments, step S310 is implemented as step S410 to step S460.

In step S410, the main router 110 determines whether the current time is a scheduled optimization time point. For example, the main router 110 updates the backhaul topology of the mesh network 10 every n minutes. Therefore, the main router 110 determines whether the current time is a scheduled optimization time point. For example, the main router 110 determines whether the current time is on the hour.

When the current time is a scheduled optimization time point (step S410 is determined as yes), in step S450, the main router 110 determines that the optimization triggering condition is satisfied. That is, when the current time is a scheduled optimization time point, the main router 110 determines that the optimization triggering condition is satisfied, and proceed to execute the update process of the backhaul topology of the mesh network 10. Based on this, the main router 110 periodically updates the backhaul topology of the mesh network 10 according to the wireless network environment.

In step S420, the main router 110 determines whether the quantity of the sub-routers 120a, 120b connected to the mesh network 10 changes. In detail, the main router 110 determines whether the sub-router quantity of the mesh network 10 changes. The main router 110 determines whether a new sub-router is added to the mesh network 10. Alternatively, the main router 110 determines whether the sub-routers 120a, 120b are removed from the mesh network 10. When removal or addition of sub-routers occurs, the sub-router quantity of the mesh network 10 will change.

When the quantity of the sub-routers 120a, 120b connected to the mesh network 10 changes (step S420 is determined as yes), in step S450, the main router 110 determines that the optimization triggering condition is satisfied. Based on this, the main router 110 updates the backhaul topology of the mesh network 10 in response to the change in the sub-router quantity of the mesh network 10.

In step S430, the main router 110 determines whether a connection quality parameter measured by each sub-router 120a, 120b in the mesh network satisfies a change condition. The connection quality parameter comprises Received Signal Strength Indicator (RSSI), Transmission Opportunity (TXOP), Signal-to-Noise Ratio (SNR), Packet Loss Rate, Latency, or Interference Level, etc.

Specifically, based on the current backhaul topology, each sub-router 120a, 120b establishs wireless connections with other sub-routers and/or with the main router 110, and each sub-router 120a, 120b periodically performs connection quality measurement on one or more wireless connections to periodically obtain connection quality parameters of the one or more wireless connections. Each sub-router 120a, 120b report the measurement results (i.e., the connection quality parameters of the wireless connections) to the main router 110.

In some embodiments, the main router 110 compares whether the gap between a first connection quality parameter currently measured by a certain sub-router (for example, sub-router 120a) and a second connection quality parameter previously measured by the certain sub-router is greater than a threshold value. When the gap between the first connection quality parameter currently measured and the second connection quality parameter previously measured is greater than the threshold value, the main router 110 determines that the connection quality parameter measured by the certain sub-router satisfies the change condition. When the gap between the first connection quality parameter currently measured and the second connection quality parameter previously measured is not greater than the threshold value, the main router 110 determines that the connection quality parameter measured by the certain sub-router does not satisfy the change condition.

When the connection quality parameters measured by the sub-routers 120a, 120b in the mesh network 10 satisfy the change condition (step S430 is determined as yes), in step S450, the main router 110 determines that the optimization triggering condition is satisfied. Based on this, the main router 110 updates the backhaul topology of the mesh network 10 in response to obstacles or interference appearing in the wireless environment.

In step S440, the main router 110 determines whether each sub-router 120a, 120b in the mesh network 10 executes a frequency band switching operation. Taking the WiFi standard as an example, each sub-router 120a, 120b performs wireless communication with other sub-routers or the main router 110 in 2.4GHz, 5GHz, or 6GHz frequency bands. For example, when serious interference appears in the wireless environment, the main router 110 controls each sub-router 120a, 120b to switch from operating at 2.4GHz to operating at 5GHz. Alternatively, when serious interference appears in the wireless environment, each sub-router 120a, 120b executes the frequency band switching operation by itself and switch from operating at 2.4GHz to operating at 5GHz.

When at least one of the sub-routers 120a, 120b in the mesh network 10 executes a frequency band switching operation (step S440 is determined as yes), in step S450, the main router 110 determines that the optimization triggering condition is satisfied. When the sub-routers 120a, 120b execute a frequency band switching operation due to signal interference, for example switching from 2.4GHz to 5GHz, the main router 110 determines that the optimization triggering condition is satisfied. Based on this, the main router 110 updates the backhaul topology of the mesh network 10 in response to the sub-routers 120a, 120b executing the frequency band switching operation.

In step S460, the main router 110 determines that the optimization triggering condition is not satisfied. That is, when the current time is not a scheduled optimization time point, the sub-router quantity of the mesh network 10 has not changed, the connection quality parameters measured by the sub-routers 120a, 120b of the mesh network 10 have not significantly changed, and the sub-routers 120a, 120b of the mesh network 10 have not executed frequency band switching operations, the main router 110 decides not to update the backhaul topology of the mesh network 10.

Returning to FIG. 3, in step S320, when the optimization triggering condition is satisfied (step S310 is determined as yes), the main router 110 determines a path cost of each of a plurality of direct link paths DL1 to DL3 according to the wireless environment information of each of the sub-routers 120a, 120b of the mesh network.

In some embodiments, the wireless environment information of each sub-router 120a, 120b comprises site scan information of each sub-router 120a, 120b, and the path cost of each direct link path DL1 to DL3 is determined based at least on connection quality parameters in the site scan information. Furthermore, each sub-router 120a, 120b executes site scanning. The sub-routers 120a, 120b detects information such as available wireless access points in the surroundings, signal strength, spectrum usage conditions, and interference levels. The site scan information obtained from site scanning is configured to evaluate network conditions and provides basic information for the main router 110 to optimize the backhaul path configuration of the mesh network 10. The sub-routers 120a, 120b report the site scan information to the main router 110.

In some embodiments, when each of the sub-routers 120a, 120b and the main router 110 execute site scanning, the active end transmits a probe request signal, and the passive end replies with a probe response signal. Through the transmission of the probe request signal and the probe response signal, the connection quality parameters of the direct link paths DL1 to DL3 between the active end and the passive end is estimated. For example, the sub-router 120a transmits a Probe Request signal. In response to receiving the probe request signal from the sub-router 120a, the sub-router 120b replies with a probe response signal. Through the transmission of the probe request signal and the probe response signal, the connection quality parameters of the direct link path DL3 between the sub-router 120a and the sub-router 120b is estimated.

In some embodiments, the connection quality parameters comprises received signal strength indicator, transmission opportunity (TXOP), or combinations thereof. The connection quality parameters in the site scan information comprises received signal strength indicator, transmission opportunity, or combinations thereof of the direct link paths DL1 to DL3.

In some embodiments, the main router 110 determines the path cost of the direct link path DL3 according to the RSSI of the direct link path DL3. The main router 110 determines the path cost of the direct link path DL2 according to the RSSI of the direct link path DL2. The main router 110 determines the path cost of the direct link path DL1 according to the RSSI of the direct link path DL1. The path costs of the direct link paths DL1 to DL3 each is negatively correlated to the RSSI of the direct link paths DL1 to DL3. The main router 110 determines the path costs of the direct link paths DL1 to DL3 through lookup table or cost function calculation.

In step S330, the main router 110 determines an optimal backhaul path for each of the sub-routers 120a, 120b to connect to the main router 110 according to the respective path costs of the direct link paths DL1 to DL3.

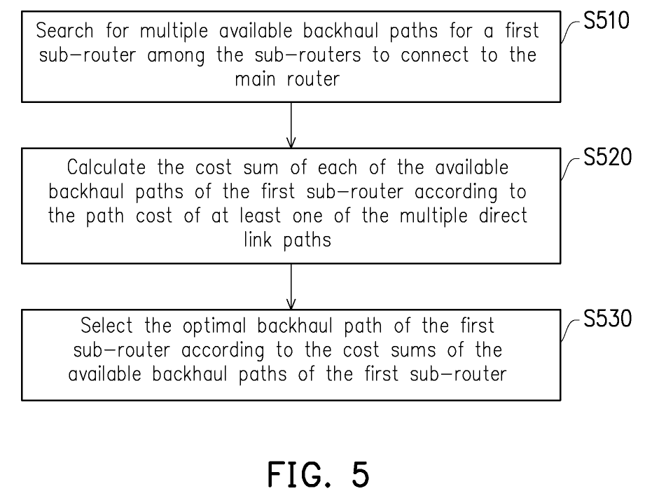

Referring to FIG. 5, which is a flowchart of determining the optimal backhaul path according to an embodiment of the disclosure. In some embodiments, step S330 comprise steps S510 to S530. In step S510, the main router 110 searches for a plurality of available backhaul paths for a first sub-router among the sub-routers 120a, 120b to connect to the main router 110. Here, the first sub-router is any one of the sub-routers 120a, 120b. These available backhaul paths comprises directly connected direct link paths (for example, single-hop links between the sub-router 120a and the main router 110) as well as multi-hop links that need to relay through multiple sub-routers.

In step S520, the main router 110 calculates the cost sum of each of the available backhaul paths of the first sub-router according to the path cost of at least one of the direct link paths. Then, in step S530, the main router 110 selects the optimal backhaul path of the first sub-router according to the cost sums of the available backhaul paths of the first sub-router. In some embodiments, the main router 110 selects the optimal backhaul path with the lowest cost sum by comparing the cost sums of the available backhaul paths of the first sub-router with each other.

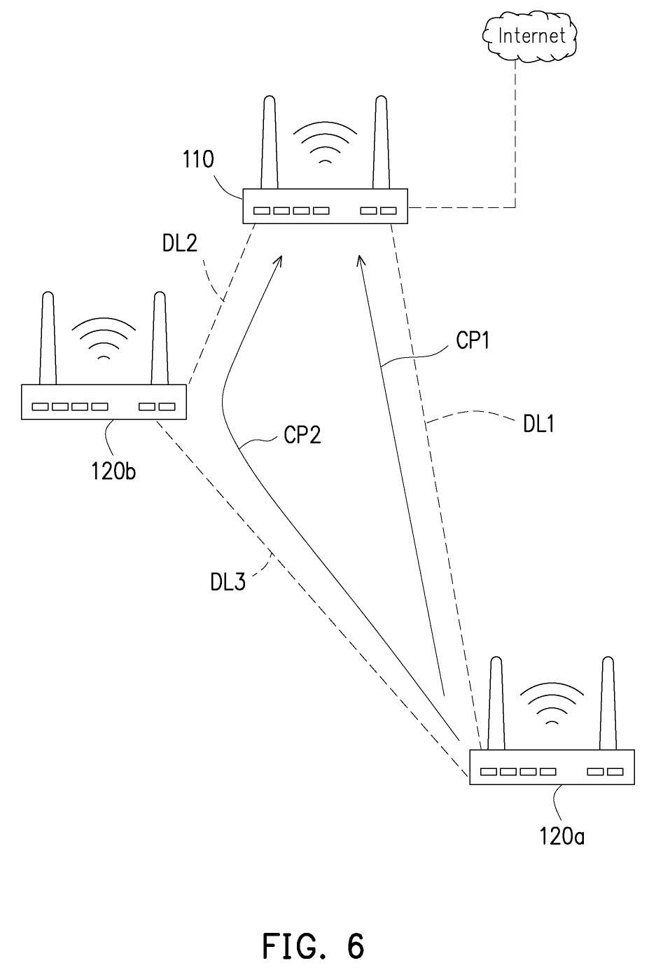

For example, FIG. 6 is a schematic diagram of determining the optimal backhaul path according to an embodiment of the disclosure. First, based on the direct link paths DL1 to DL3, the main router 110 searches for multiple available backhaul paths CP1 to CP2 for the sub-router 120a to connect to the main router 110. Assume that the path cost of the direct link path DL1 is "1", the path cost of the direct link path DL3 is "1", and the path cost of the direct link path DL2 is "4". The main router 110 calculates that the cost sum of the backhaul path CP1 is 4 and the cost sum of the backhaul path CP2 is 2 (1+1=2). In this case, since the cost sum of the backhaul path CP2 is less than the cost sum of the backhaul path CP1, the main router 110 selects the backhaul path CP2 as the optimal backhaul path of the sub-router 120a. According to the same approach, the main router 110 determines the optimal backhaul path of the sub-router 120b.

Returning to FIG. 3, in step S340, the main router 110 controls each of the sub-routers 120a, 120b to connect to the mesh network 10 according to the corresponding optimal backhaul path. In some embodiments, the main router 110 updates the routing table or backhaul topology of each sub-router 120a, 120b, and write the new routing table or new backhaul topology into the storage device of each sub-router 120a, 120b. In this way, the sub-routers 120a, 120b connects to the mesh network 10 according to the updated routing table or the updated backhaul topology.

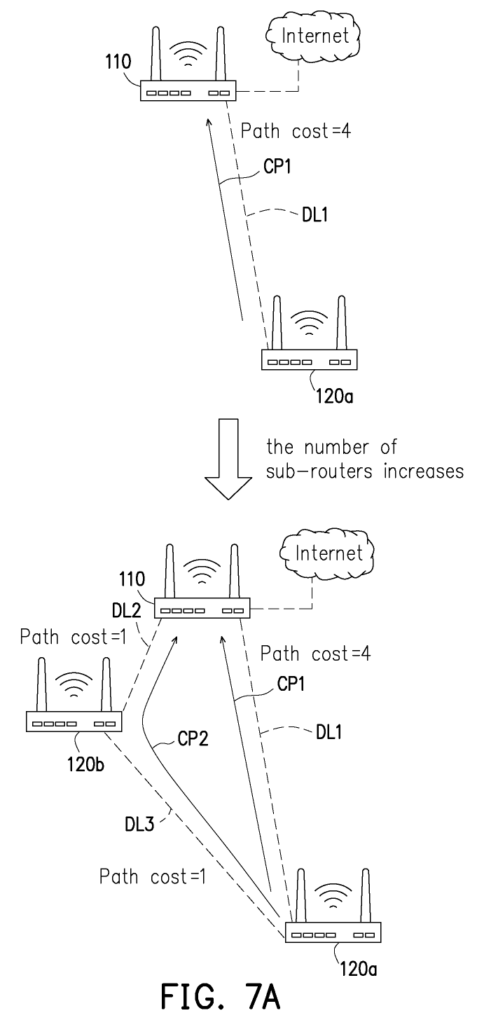

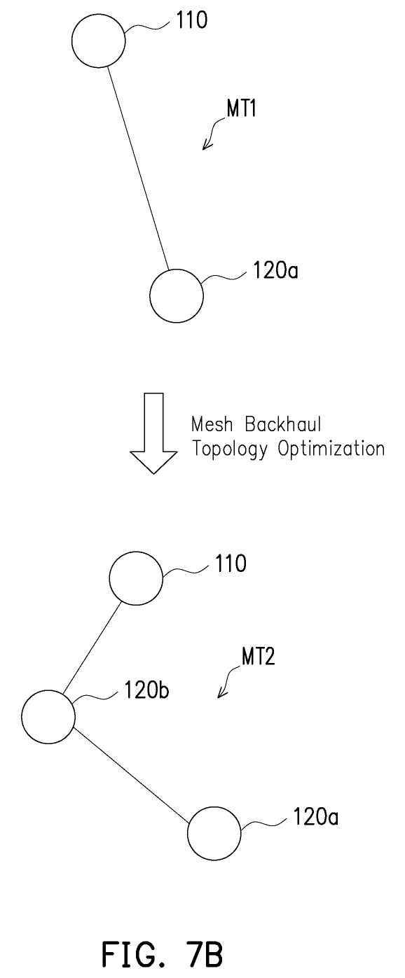

Referring to FIG. 7A, which is a schematic diagram of a scenario for updating the optimal backhaul path according to an embodiment of the disclosure. Before the sub-router 120b joins the mesh network, since the sub-router 120a merely has one available backhaul path CP1, the main router 110 selects the available backhaul path CP1 as the optimal backhaul path of the sub-router 120a.

Afterwards, when the sub-router 120b powers on and joins the mesh network, the sub-router 120b connects to the main router 110 according to the direct link path DL2. Thus, when the sub-router 120b connects to the main router 110, the main router 110 determines that the sub-router quantity increases. The main router 110 determines that the optimization triggering condition is satisfied due to the increase in sub-router quantity and decide to adjust the backhaul topology of the mesh network. Thus, the main router 110 controls the sub-routers 120a, 120b to enter site scan mode to obtain respective site scan information, and report the site scan information to the main router 110. The main router 110 calculates the path cost of each direct link path DL1 to DL3 according to the site scan information of the sub-routers 120a, 120b. Since the cost sum "2" of the available backhaul path CP2 is less than the cost sum "4" of the available backhaul path CP1, the main router 110 selects the available backhaul path CP2 as the optimal backhaul path of the sub-router 120a. That is, in response to the sub-router 120b joining the mesh network, the optimal backhaul path of the sub-router 120a will be updated from the available backhaul path CP1 to the available backhaul path CP2.

In this case, referring to FIG. 7B, which is a schematic diagram of topology optimization of mesh backhaul according to an embodiment of the disclosure. In response to the sub-router 120b joining the mesh network, the main router 110 updates the backhaul topology MT1 to the backhaul topology MT2. Thus, the main router 110 configures the topology information of the backhaul topology MT2 or corresponding routing rules to the sub-router 120a and the sub-router 120b, so that the sub-router 120a and the sub-router 120b establish the mesh network according to the backhaul topology MT2.

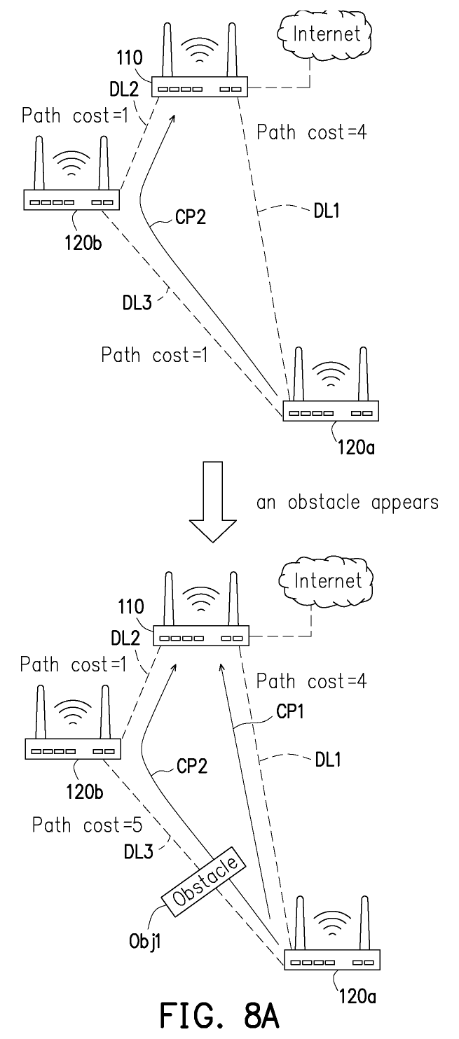

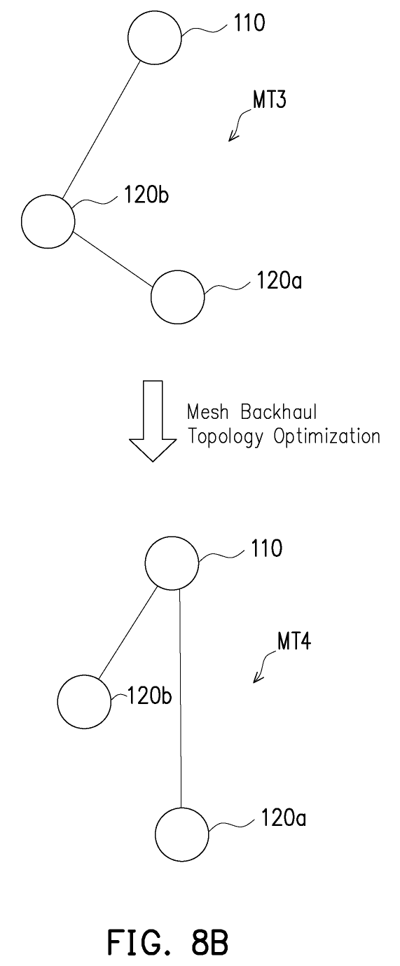

FIG. 8A is a schematic diagram of a scenario for updating the optimal backhaul path according to an embodiment of the disclosure. Before the obstacle Obj1 appears, based on the path cost of the direct link paths DL1 to DL3, the main router 110 selects the available backhaul path CP2 as the optimal backhaul path of the sub-router 120a. After the obstacle Obj1 appears, the connection quality parameter of the direct link path DL3 changes significantly, therefore the main router 110 determines that the optimization triggering condition is satisfied because the connection quality parameter of the direct link path DL3 satisfies the change condition. Thus, the main router 110 controls the sub-routers 120a, 120b to enter site scan mode to obtain respective site scan information, and report the site scan information to the main router 110. The main router 110 calculates the path cost of each direct link path DL1 to DL3 according to the site scan information of the sub-routers 120a, 120b. After the obstacle Obj1 appears, the path cost of the direct link path DL3 increases from 1 to 5. Therefore, since the cost sum of the available backhaul path CP2 changes to be greater than the cost sum of the available backhaul path CP1, the main router 110 selects the available backhaul path CP1 as the optimal backhaul path of the sub-router 120a. That is, in response to the obstacle Obj1 appearing, the optimal backhaul path of the sub-router 120a will be updated from the available backhaul path CP2 to the available backhaul path CP1.

In this case, referring to FIG. 8B, which is a schematic diagram of topology optimization of mesh backhaul according to an embodiment of the disclosure. In response to the obstacle Obj1 appearing, the main router 110 updates the backhaul topology MT3 to the backhaul topology MT4. Thus, the main router 110 configures the topology information of the backhaul topology MT4 or corresponding routing rules to the sub-router 120a and the sub-router 120b, so that the sub-router 120a and the sub-router 120b establish the mesh network according to the backhaul topology MT4.

In summary, in the embodiment of the disclosure, the main router determines whether the optimization triggering condition is satisfied. In response to determining that the optimization triggering condition is satisfied, the main router collects wireless environment information of each of the sub-routers of the mesh network to determine the path cost of each of direct link paths. Thus, the main router determines the optimal backhaul path for each sub-router to connect to the main router according to the path cost of each of the direct link paths, so that each sub-router connects to the mesh network according to the corresponding optimal backhaul path. In this way, the main router updates the topology structure of the mesh backhaul in response to changes in wireless environment conditions or scheduled optimization time points, thereby optimizing the network performance of the mesh network and improving transmission stability.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A mesh backhaul topology optimization method, adapted to a main router of a mesh network, the method comprising:
determining whether an optimization triggering condition is satisfied;
determining a path cost of each of a plurality of direct link paths according to wireless environment information of a plurality of sub-routers of the mesh network when the optimization triggering condition is satisfied;
determining an optimal backhaul path for each of the plurality of sub-routers to connect to the main router according to the path costs of the plurality of direct link paths; and
controlling each of the plurality of sub-routers to connect to the mesh network according to the corresponding optimal backhaul path.

2. The mesh backhaul topology optimization method as claimed in claim 1, wherein the step of determining whether the optimization triggering condition is satisfied comprises:
determining whether a current time is a scheduled optimization time point; and
determining that the optimization triggering condition is satisfied when the current time is the scheduled optimization time point.

3. The mesh backhaul topology optimization method as claimed in claim 1, wherein the step of determining whether the optimization triggering condition is satisfied comprises:
determining whether each of the plurality of sub-routers in the mesh network executes a frequency band switching operation; and
determining that the optimization triggering condition is satisfied when at least one of the plurality of sub-routers in the mesh network executes the frequency band switching operation.

4. The mesh backhaul topology optimization method as claimed in claim 1, wherein the step of determining whether the optimization triggering condition is satisfied comprises:
determining whether a quantity of the plurality of sub-routers connected to the mesh network is changed; and
determining that the optimization triggering condition is satisfied when the quantity of the plurality of sub-routers connected to the mesh network is changed.

5. The mesh backhaul topology optimization method as claimed in claim 1, wherein the step of determining whether the optimization triggering condition is satisfied comprises:
determining whether a connection quality parameter measured by each of the plurality of sub-routers in the mesh network satisfies a change condition; and
determining that the optimization triggering condition is satisfied when the connection quality parameter measured by the plurality of sub-routers in the mesh network satisfies the change condition.

6. The mesh backhaul topology optimization method as claimed in claim 1, wherein the wireless environment information of each of the plurality of sub-routers comprises site scan information of each of the plurality of sub-routers, and the path cost of each of the plurality of direct link paths is determined based at least on a connection quality parameter in the site scan information.

7. The mesh backhaul topology optimization method as claimed in claim 6, wherein the connection quality parameter comprises a received signal strength indicator, a transmission opportunity (TXOP), or a combination thereof.

8. The mesh backhaul topology optimization method as claimed in claim 1, wherein the step of determining the optimal backhaul path for each of the plurality of sub-routers to connect to the main router according to the path cost of each of the plurality of direct link paths comprises:
searching for a plurality of available backhaul paths for a first sub-router among the plurality of sub-routers to connect to the main router;
calculating a cost sum of each of the plurality of available backhaul paths of the first sub-router according to the path cost of at least one of the plurality of direct link paths; and
selecting the optimal backhaul path of the first sub-router according to the cost sums of the plurality of available backhaul paths of the first sub-router.

9. The mesh backhaul topology optimization method as claimed in claim 1, wherein the step of selecting the optimal backhaul path of the first sub-router according to the cost sums of the plurality of available backhaul paths of the first sub-router comprises:
selecting the optimal backhaul path with a lowest cost sum by comparing the cost sums of the plurality of available backhaul paths of the first sub-router.

10. A router device serving as a main router of a mesh network and comprising:
a transceiver;
a storage device; and
a processor coupled to the transceiver and the storage device, configured to:
determine whether an optimization triggering condition is satisfied;
determine a path cost of each of a plurality of direct link paths according to wireless environment information of a plurality of sub-routers of the mesh network when the optimization triggering condition is satisfied;
determine an optimal backhaul path for each of the plurality of sub-routers to connect to the main router according to the path costs of the plurality of direct link paths; and
control each of the plurality of sub-routers to connect to the mesh network according to the corresponding optimal backhaul path.
